(19) United States
(12) Patent Application Publication
(10) Pub. No.: US 2014/0021790 A1
(43) Pub. Date: Jan. 23, 2014

(54) METHOD FOR CONTROLLING OUTPUT WAVEFORMS OF AN UNINTERRUPTIBLE POWER SUPPLY

(71) Applicant: Jian Wang, TAIPEI (TW)

(72) Inventor: Jian Wang, TAIPEI (TW)

(73) Assignee: CYBER POWER SYSTEMS INC., TAIPEI (TW)

(21) Appl. No.: 13/555,413

(22) Filed: Jul. 23, 2012

(51) Int. Cl. H02J 9/00; H02J 7/00

(52) U.S. Cl. 307/66

(57) ABSTRACT

A method for controlling output waveforms of an uninterruptible power supply (UPS) provides multiple types of output waveforms through a UPS for users to selectively switch to a waveform of output power after the UPS enters a battery mode. The output waveforms include square wave and sinusoidal wave. Based on load characteristics, users can choose either square wave or sinusoidal wave as the waveform of the output power. Accordingly, single UPS can meet the demand of high efficiency and longer discharge time or better output characteristics and low noise according to different load conditions.

### BACKGROUND OF THE INVENTION

1. Field of the Invention

The present invention relates to an uninterruptible power supply (UPS) and more particularly to a UPS capable of selectively outputting power with different waveforms and a method for controlling output waveforms of a UPS.

2. Description of the Related Art

Regular UPSs are dedicated to circumstances running into abnormal mains power, such as power outage, over-voltage/under-voltage power or surge current, to provide backup power to power-consuming equipment so that the power-consuming equipment can receive an operating power in an uninterruptible fashion. Therefore, mission critical commercial equipment such as computers, telecommunication network, private branch exchange (PBX) and the like, can be prevented from losing data or control due to mains power failure. Conventional UPSs can be generally classified into on-line UPSs, off-line UPSs and line-interactive UPSs, and their characteristics are briefly described as follows.

An on-line UPS serves to separate a load from mains power. Instead of being directly supplied to the load, mains power is supplied to a UPS and is converted into DC power to charge a battery. Meanwhile, the DC power is converted back to AC power to supply the AC power to the load. In the event of an outage or irregularity of mains power, the on-line UPS is switched and operated under a battery mode to convert the DC power of the battery into AC power and continuously supply the AC power to the load. Furthermore, the waveforms outputted by the on-line UPSs are sinusoidal and identical to that of mains power. Since the output waveform is sinusoidal, the on-line UPSs are applicable to purely inductive loads, purely capacitive loads and mixed loads of both, and are thus advantageous in better output characteristics and lower noise.

An off-line UPS plays a role of backup power. During a normal state, mains power directly supplies power to a load and simultaneously charges a battery. In the event of an outage of mains power, a power supply loop of the UPS connected to mains power is automatically switched off and the off-line UPS enters a battery mode to convert the DC power of the battery into AC power and supply the AC power to the load. As the AC power converted from the DC power of the battery takes the form of a square wave, the power efficiency is high and green environment can be fulfilled. When identical batteries are equipped, the off-line UPSs have longer discharge time. However, the off-line UPSs can supply power purely capacitive loads.

A line-interactive UPS is equipped with a boost and buck compensation circuit, is operated basically the same as an off-line UPS, and does not intervene to supply power throughout entire operation thereof but instantaneously monitors the power supply condition of mains power. In the event of abnormal mains power, the line-interactive UPS is instantaneously calibrated (voltage boost or buck) or enters a battery mode to replace mains power in continuously supplying power to a load.

From the foregoing, each type of UPSs has its specific operational theories and is applicable to specific loads. However, under the battery mode, each UPS can output only one waveform, such as square wave or sinusoidal wave. The power efficiency of the square wave is higher compared with that of the sinusoidal wave, and batteries outputting power with square wave have longer discharge time, are not easy to cause battery loss and ensure more environmental protection. UPSs outputting power with sinusoidal waves have higher switching loss and lower power efficiency due to pulse width modulation (PWM) operation at high frequency but have lower noise and better output characteristics when applied to purely inductive loads, purely capacitive loads and mixed loads of both. Hence, no matter if the UPSs outputting power with square waves or the UPSs outputting power with square waves, each type of UPSs has its own pros and cons in operation. However, if each UPS can only output power with one waveform, manufacturers of UPSs must provide two types of UPSs to satisfy different needs of users, and once the load is changed, users must purchase new UPS again in compliance with the load characteristics. To manufacturers and users of UPSs, the issues associated with cost increase and unnecessary expenditure are inevitable.

### SUMMARY OF THE INVENTION

A first objective of the present invention is to provide a method for controlling output waveforms of a UPS provides multiple types of output waveforms through a UPS for users to selectively switch to a waveform of output power. If a sinusoidal wave is selected, it is applicable to a purely inductive load, a purely capacitive load or a mixed load of both and is advantageous in better output characteristics and lower noise. If a square wave is selected, it is applicable to purely capacitive load and is advantageous in high efficiency, green environment and longer discharge time.

To achieve the foregoing objective, in the method the UPS has a controller and a full-bridge inverter, the full-bridge inverter has four power switches, and the controller has four driving signal output terminals respectively connected to the four power switches of the full-bridge inverter and is built in with an output waveform switching process, the output waveform switching process has steps of:

providing multiple waveform output modes for each waveform output mode to correspond to one kind of driving signal for outputting a corresponding waveform;

accepting an output waveform selection command to select one of the waveform output modes.

determining if entering a battery mode;

if entering the battery mode, according to the selected waveform output mode, outputting a corresponding driving signal to each of the four power switches of the full-bridge inverter to control a duty cycle of each power switch, and enable the UPS to output the corresponding waveform.

The waveform output modes may be a square wave output mode and a sinusoidal wave output mode. When the square wave output mode is selected, the controller generates a square wave driving signal and send it to each of the four power switches of the full-bridge inverter to control the duty cycle of the power switch so that the UPS outputs an AC power having a square waveform to a load. When the sinusoidal wave output mode is selected, the controller generates a sinusoidal wave driving signal and send it to each of the four power switches of the full-bridge inverter to control the duty cycle of the power switch so that the UPS outputs an AC power having a sinusoidal waveform to a load. The benefit of using the foregoing method lies in that single one UPS can provide AC power having a square waveform or a sinusoidal waveform to the load and users can select an output waveform of the UPS according to the load characteristics so as to effectively lower equipment cost and provide more operational flexibility.

A second objective of the present invention is to provide a UPS capable of generating different output waveforms.

To achieve the foregoing objective, the UPS has a full-bridge inverter, a battery set, a charger and a controller.

The full-bridge inverter has an input terminal and an output terminal and is composed of four power switches.

The battery set is connected to the input terminal of the full-bridge inverter.

The charger has an input terminal and an output terminal. The input terminal is adapted to connect to the AC mains through a rectifier. The output terminal is connected to the battery set.

The controller has a switch command input terminal, multiple driving signal output terminals and a charge control terminal. Each driving signal output terminal is connected to one of the four power switches of the full-bridge inverter to control a duty cycle of the power switch. The charge control terminal connected to the charger.

The controller is built in with an output waveform switching process selecting a driving signal with a waveform according to a switch command inputted through the switch command input terminal to control the duty cycle of each power switch.

Using the foregoing UPS can select one of multiple output waveforms of the UPS for users to conveniently select a proper output waveform according to load characteristics. When the UPS enters the battery mode, the UPS outputs AC power with the selected output waveform to the load.

Other objectives, advantages and novel features of the invention will become more apparent from the following detailed description when taken in conjunction with the accompanying drawings.

### BRIEF DESCRIPTION OF THE DRAWINGS

FIG. 1 is a circuit diagram of a first embodiment of a UPS in accordance with the present invention;

FIG. 2A is a circuit diagram partially showing a second embodiment of a UPS in accordance with the present invention;

FIG. 2B is a circuit diagram partially showing a third embodiment of a UPS in accordance with the present invention;

FIG. 3 is a flow diagram of a method for controlling output waveforms of a UPS in accordance with the present invention;

FIG. 4 is a waveform diagram of driving signals when the method in FIG. 3 is executed to output a square wave;

FIG. 5A is a waveform diagram of driving signals when the method in FIG. 3 is executed to output a sinusoidal wave;

FIG. 5B is another waveform diagram of driving signals when the method in FIG. 3 is executed to output a sinusoidal wave;

FIG. 6A is a waveform diagram of driving signals when the method in FIG. 3 is executed to output a stepwise wave; and

FIG. 6B is another waveform diagram of driving signals when the method in FIG. 3 is executed to output a stepwise wave.

### DETAILED DESCRIPTION OF THE INVENTION

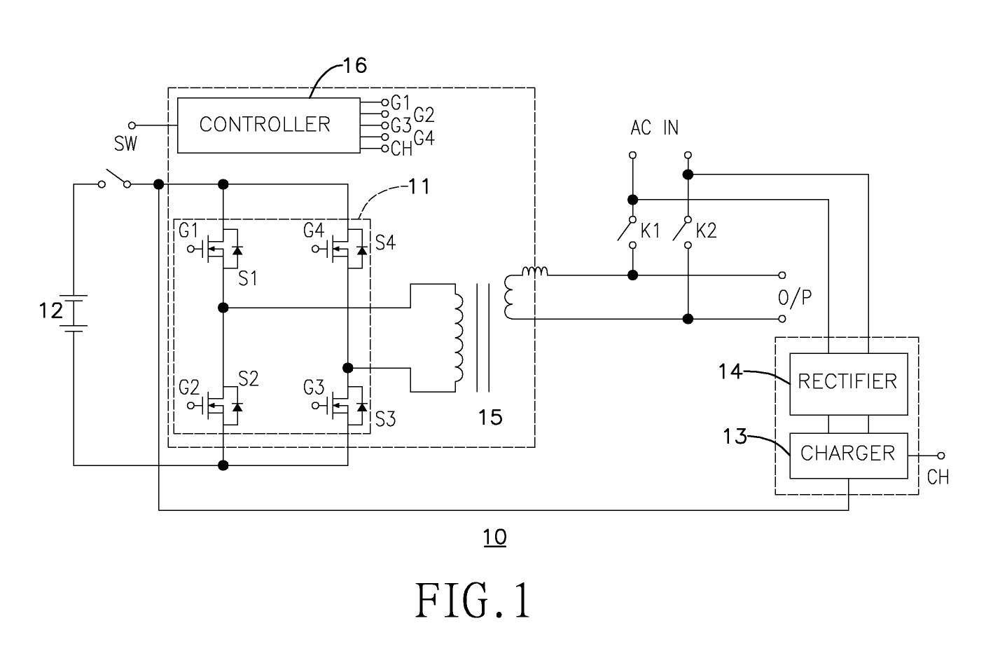

With reference to FIG. 1, a first embodiment of a UPS in accordance with the present invention has a full-bridge inverter 11, a battery set 12, a charger 13, a controller 16 and a transformer 15.

The full-bridge inverter 11 has an input terminal and an output terminal and is composed of four power switches S1˜S4. In the present embodiment, each power switch S1˜S4 is a metal oxide semiconductor field effect transistor (MOSFET).

The battery set 12 is connected to the input terminal of the full-bridge inverter 11.

The charger 13 has an input terminal and an output terminal. The input terminal of the charger 13 is connected to the AC mains (AC IN) through a rectifier 14, and the output terminal of the charger 13 is connected to the battery set 12.

The controller 16 has a switch command input terminal SW, multiple driving signal output terminals G1˜G4 and a charge control terminal CH. Each driving signal output terminal G1˜G4 is connected to the gate of one of the MOSFETs in the UPS to control a duty cycle of the MOSFET. The charge control terminal CH is connected to the charger 13. The controller 16 is built in with an output waveform switching process selecting a driving signal with a waveform according to a switch command inputted through the switch command input terminal SW to control the duty cycle of each MOSFET.

The transformer 15 has a primary side and a secondary side. The primary side is connected to the output terminal of the full-bridge inverter 11 and the secondary side is connected to a power output terminal 0/P for filtering.

A method for controlling output waveforms of a UPS in accordance with the present invention is applicable to each of an on-line UPS, an off-line UPS and a line-interactive UPS. In the present embodiment, the method is applicable to a line-interactive UPS. Hence, the foregoing power output terminal O/P is connected to the AC mains (AC IN) through two switches K1 and K2. When the mains power (AC IN) is normal and the switches K1 and K2 are closed, the mains power not only supplies power to a load through the power output terminal O/P but also charges the battery set 12 through the charger 13. When the mains power (AC IN) is abnormal, the switches K1 and K2 are opened, the charger 13 no longer charges the battery set 12 and enters a battery mode, the battery set 12 outputs DC power to the full-bridge inverter 11, and the controller 16 drives the full-bridge inverter 11 to convert the DC power into AC power and supplies the AC power to the load.

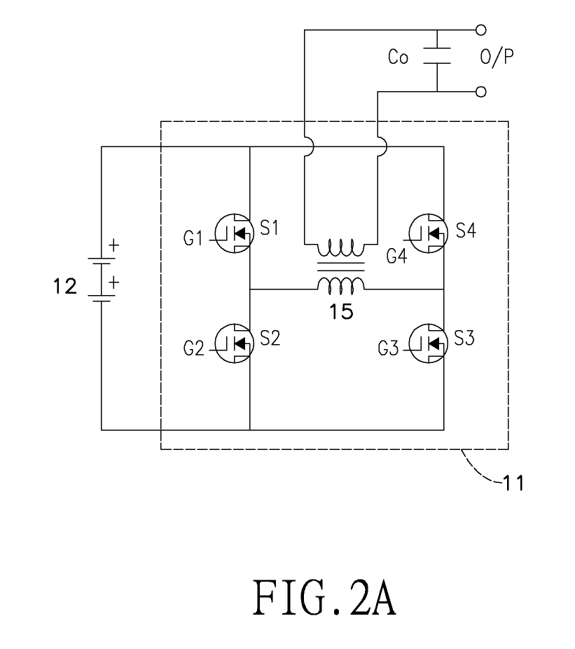

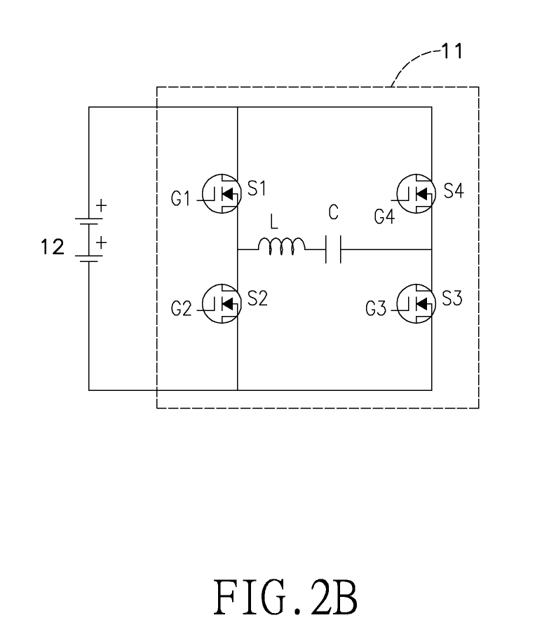

With reference to FIG. 2A, a second embodiment of a UPS in accordance with the present invention is shown. The transformer 15 connected to the output terminal of the full-bridge inverter 11 further has an output capacitor Co parallelly connected to the secondary side thereof. With reference to FIG. 2B, a third embodiment of a UPS in accordance with the present invention is shown. Not only can the output terminal of the full-bridge inverter 11 be connected to the transformer 15 to serve as a filtering circuit, but also the filtering circuit can be composed of an inductor L and a capacitor C connected in series to each other.

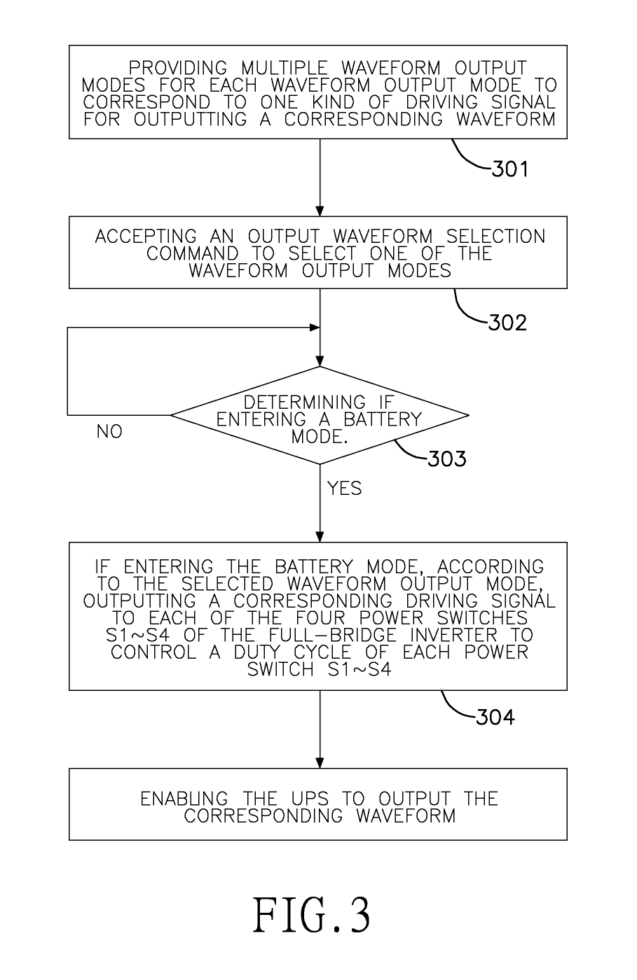

With reference to FIG. 3, a method for controlling output waveforms of a UPS in accordance with the present invention is executed by a UPS having a full-bridge inverter, corresponds to the built-in output waveform switching process embedded in the UPS, and has the following steps.

Step 301: Provide multiple waveform output modes for each waveform output mode to correspond to one kind of driving signal for outputting a corresponding waveform. In the present embodiment, a square wave output mode and a sinusoidal wave output mode are provided. The square wave output mode and the sinusoidal wave output mode respectively correspond to a driving signal for outputting a square wave and a driving signal for outputting a sinusoidal wave.

Step 302: Accept an output waveform selection command to select one of the waveform output modes.

Step 303: Determine if entering a battery mode.

Step 304: If entering the battery mode, according to the selected waveform output mode, output a corresponding driving signal to each of the four power switches S1˜S4 of the full-bridge inverter 11 to control a duty cycle of each power switch S1˜S4, and enable the UPS to output the corresponding waveform.

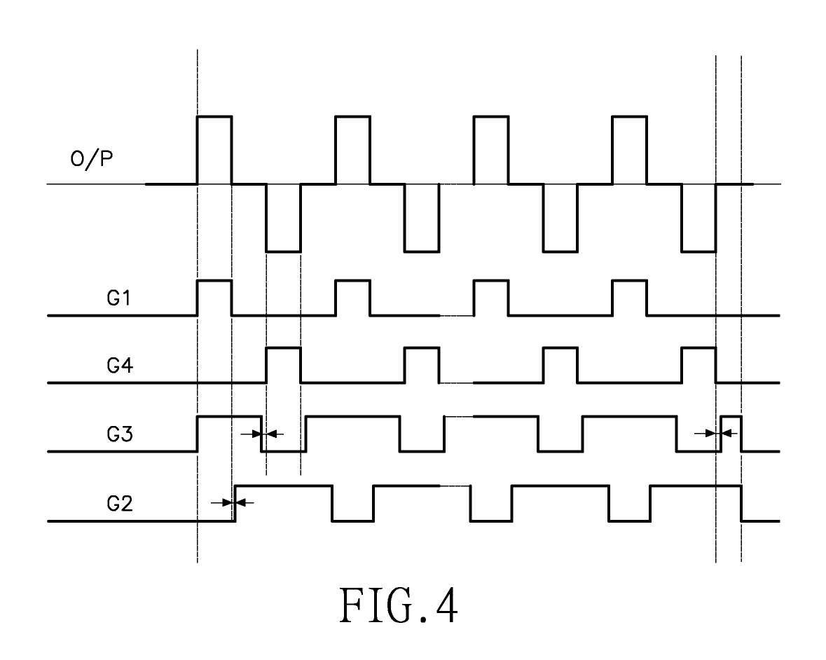

As mentioned, the waveform output mode may be a square wave output mode and a sinusoidal wave output mode. When the switch command input terminal SW of the controller 16 receives a square wave selection command, the UPS is set up to output AC power with a square waveform. When the UPS enters the battery mode, the controller 16 generates a corresponding square wave driving signal to each of the four power switches S1˜S4 of the full-bridge inverter 11 to control its duty cycle. With reference to FIG. 4, a square wave driving signal of each driving signal output terminal G1˜G4 of the controller 16 is shown. A low-frequency square signal is used to drive each power switch S1˜S4 of the full-bridge inverter 11 so that AC power with a square waveform is outputted from the power output terminal 0/P of the UPS.

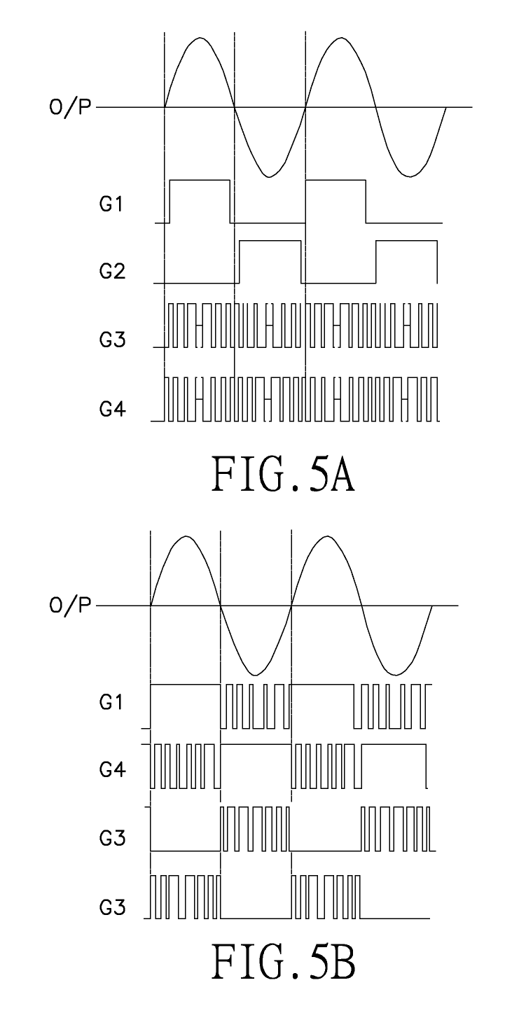

When the switch command input terminal SW of the controller 16 receives a sinusoidal wave selection command, the UPS is set up to output AC power with a sinusoidal waveform. When the UPS enters the battery mode, the controller 16 generates a corresponding sinusoidal wave driving signal to each of the four power switches S1˜S4 of the full-bridge inverter 11 to control its duty cycle. With reference to FIGS. 5A and 5B, a sinusoidal driving signal of each driving signal output terminal G1˜G4 of the controller 16 is shown. Alternately turn-on square wave signals of G1 and G4 together with complementary sinusoidal pulse width modulation signals (SPWM) of G2 and G3 are used to respectively drive the four power switches S1˜S4 of the full-bridge inverter 11 so that AC power with a sinusoidal waveform is outputted from the power output terminal O/P of the UPS.

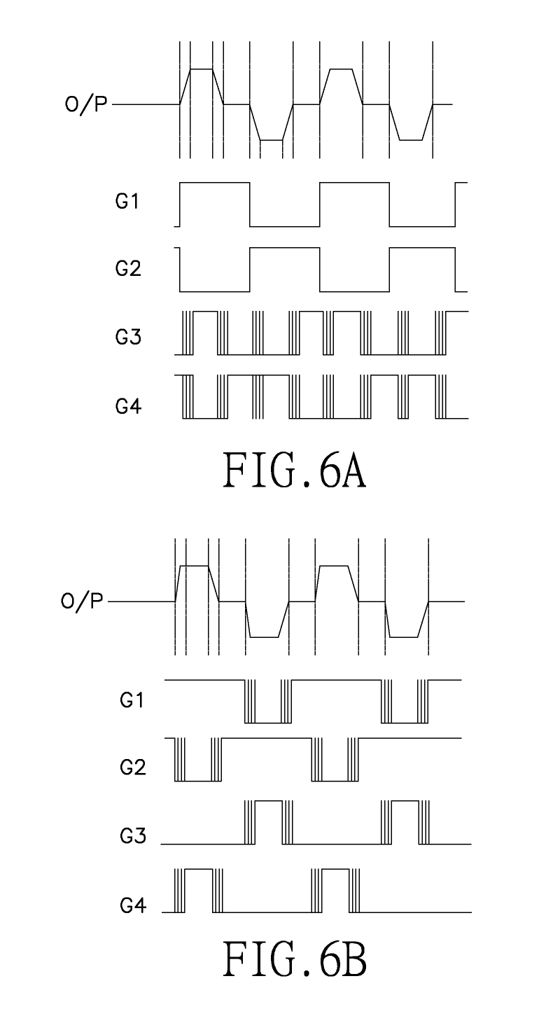

Besides the square wave output mode and the sinusoidal wave output mode, the waveform output mode may output a stepwise wave, which pertains to a waveform between the square wave and the sinusoidal wave, has a higher output efficiency than the sinusoidal wave does and has a better output characteristics than the square wave does. To output AC power with stepwise waveform from the UPS, the controller 16 provides a first order stepwise wave output mode. When the switch command input terminal SW of the controller 16 receives a stepwise wave selection command, the UPS is set up to output AC power with a stepwise waveform. When the UPS enters the battery mode, the controller 16 generates a corresponding stepwise wave driving signal to each of the four power switches S1˜S4 of the full-bridge inverter 11 to control its duty cycle A so that AC power with a stepwise waveform is outputted from the power output terminal O/P of the UPS. With reference to FIG. 6A and 6B, a stepwise wave driving signal of each driving signal output terminal G1˜G4 of the controller 16 is shown.

As for the input means of the output waveform selection command, the input means includes but not limited to the following.

1. A communication port is connected to the switch command input terminal SW of the controller 16. The communication port may be a wired communication port or a wireless communication port for users to externally input the output waveform selection command through the wired or wireless communication port from outside the UPS.

2. An operation panel is mounted on a body of the UPS. The operation panel has at least one selection key connected to the switch command input terminal SW of the controller 16 through a switch detection circuit, thereby outputting the output waveform selection command to the controller through the at least one selection key on the operation panel.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A method for controlling output waveforms of a UPS, wherein the UPS has a controller and a full-bridge inverter, the full-bridge inverter has four power switches, and the controller has four driving signal output terminals respectively connected to the four power switches of the full-bridge inverter and is built in with an output waveform switching process, the output waveform switching process comprising steps of:
providing multiple waveform output modes for each waveform output mode to correspond to one kind of driving signal for outputting a corresponding waveform;
accepting an output waveform selection command to select one of the waveform output modes;
determining if entering a battery mode;
if entering the battery mode, according to the selected waveform output mode, outputting a corresponding driving signal to each of the four power switches of the full-bridge inverter to control a duty cycle of each power switch, and enable the UPS to output the corresponding waveform.

2. The method as claimed in claim 1, wherein the waveform output modes have a square wave output mode and a sinusoidal wave output mode, and the controller respectively generates a square wave driving signal and a sinusoidal wave driving signal according to the square wave output mode and the sinusoidal wave output mode.

3. The method as claimed in claim 2, wherein the waveform output modes further have a stepwise wave output mode, and the controller generates a stepwise wave driving signal according to the stepwise wave output mode.

4. The method as claimed in claim 1, wherein the waveform output modes have a sinusoidal wave output mode and a stepwise wave output mode, and the controller respectively generates a sinusoidal wave driving signal and a stepwise wave driving signal according to the sinusoidal wave output mode and the stepwise wave output mode.

5. The method as claimed in claim 1, wherein the waveform output modes have a square wave output mode and a stepwise wave output mode, and the controller respectively generates a square wave driving signal and a stepwise wave driving signal according to the square wave output mode and the stepwise wave output mode.

6. The method as claimed in claim 2, wherein the sinusoidal driving signal has a sinusoidal pulse width modulation (SPWM) signal.

7. The method as claimed in claim 4, wherein the sinusoidal driving signal has a SPWM signal.

8. An uninterruptible power supply (UPS) comprising:
a full-bridge inverter having an input terminal and an output terminal and composed of four power switches;
a battery set connected to the input terminal of the full-bridge inverter;
a charger having:
an input terminal adapted to connect to the AC mains through a rectifier; and
an output terminal connected to the battery set; and
a controller having:
a switch command input terminal;
multiple driving signal output terminals, each driving signal output terminal connected to one of the four power switches of the full-bridge inverter to control a duty cycle of the power switch; and
a charge control terminal connected to the charger;
wherein the controller is built in with an output waveform switching process having steps of:
providing multiple waveform output modes for each waveform output mode to correspond to one kind of driving signal for outputting a corresponding waveform;
accepting an output waveform selection command to select one of the waveform output modes;
determining if entering a battery mode;
if entering the battery mode, according to the selected waveform output mode, outputting a corresponding driving signal to each of the four power switches of the full-bridge inverter to control a duty cycle of each power switch, and enable the UPS to output the corresponding waveform.

9. The UPS as claimed in claim 8, wherein the waveform output modes have a square wave output mode and a sinusoidal wave output mode, and the controller respectively generates a square wave driving signal and a sinusoidal wave driving signal according to the square wave output mode and the sinusoidal wave output mode.

10. The UPS as claimed in claim 9, wherein the waveform output modes further have a stepwise wave output mode, and the controller generates a stepwise wave driving signal according to the stepwise wave output mode.

11. The UPS as claimed in claim 8, wherein the waveform output modes have a sinusoidal wave output mode and a stepwise wave output mode, and the controller respectively generates a sinusoidal wave driving signal and a stepwise wave driving signal according to the sinusoidal wave output mode and the stepwise wave output mode.

12. The UPS as claimed in claim 8, wherein the waveform output modes have a square wave output mode and a stepwise wave output mode, and the controller respectively generates a square wave driving signal and a stepwise wave driving signal according to the square wave output mode and the stepwise wave output mode.

13. The UPS as claimed in claim 9, wherein the sinusoidal driving signal has a sinusoidal pulse width modulation (SPWM) signal.

14. The UPS as claimed in claim 11, wherein the sinusoidal driving signal has a SPWM signal.

15. The UPS as claimed in claim 8, wherein a communication port is connected to the switch command input terminal.

16. The UPS as claimed in claim 9, wherein a communication port is connected to the switch command input terminal.

17. The UPS as claimed in claim 10, wherein a communication port is connected to the switch command input terminal.

18. The UPS as claimed in claim 11, wherein a communication port is connected to the switch command input terminal.

19. The UPS as claimed in claim 12, wherein a communication port is connected to the switch command input terminal.

20. The UPS as claimed in claim 13, wherein a communication port is connected to the switch command input terminal.

21. The UPS as claimed in claim 14, wherein a communication port is connected to the switch command input terminal.

22. The UPS as claimed in claim 8, wherein the switch command input terminal of the controller is connected to a selection key on an operation panel through a switch detection circuit.

23. The UPS as claimed in claim 9, wherein the switch command input terminal of the controller is connected to a selection key on an operation panel through a switch detection circuit.

24. The UPS as claimed in claim 10, wherein the switch command input terminal of the controller is connected to a selection key on an operation panel through a switch detection circuit.

25. The UPS as claimed in claim 11, wherein the switch command input terminal of the controller is connected to a selection key on an operation panel through a switch detection circuit.

26. The UPS as claimed in claim 12, wherein the switch command input terminal of the controller is connected to a selection key on an operation panel through a switch detection circuit.

27. The UPS as claimed in claim 13, wherein the switch command input terminal of the controller is connected to a selection key on an operation panel through a switch detection circuit.

28. The UPS as claimed in claim 14, wherein the switch command input terminal of the controller is connected to a selection key on an operation panel through a switch detection circuit.

29. The UPS as claimed in claim 8, wherein the output terminal of the full-bridge inverter is connected to a primary side of a transformer, a secondary side of the transformer is connected to a power output terminal adapted to connect to the AC mains through two switches.

30. The UPS as claimed in claim 9, wherein the output terminal of the full-bridge inverter is connected to a primary side of a transformer, a secondary side of the transformer is connected to a power output terminal adapted to connect to the AC mains through two switches.

31. The UPS as claimed in claim 10, wherein the output terminal of the full-bridge inverter is connected to a primary side of a transformer, a secondary side of the transformer is connected to a power output terminal adapted to connect to the AC mains through two switches.

32. The UPS as claimed in claim 11, wherein the output terminal of the full-bridge inverter is connected to a primary side of a transformer, a secondary side of the transformer is connected to a power output terminal adapted to connect to the AC mains through two switches.

33. The UPS as claimed in claim 12, wherein the output terminal of the full-bridge inverter is connected to a primary side of a transformer, a secondary side of the transformer is connected to a power output terminal adapted to connect to the AC mains through two switches.

34. The UPS as claimed in claim 13, wherein the output terminal of the full-bridge inverter is connected to a primary side of a transformer, a secondary side of the transformer is connected to a power output terminal adapted to connect to the AC mains through two switches.

35. The UPS as claimed in claim 14, wherein the output terminal of the full-bridge inverter is connected to a primary side of a transformer, a secondary side of the transformer is connected to a power output terminal adapted to connect to the AC mains through two switches.

36. The UPS as claimed in claim 15, wherein the output terminal of the full-bridge inverter is connected to a primary side of a transformer, a secondary side of the transformer is connected to a power output terminal adapted to connect to the AC mains through two switches.

37. The UPS as claimed in claim 16, wherein the output terminal of the full-bridge inverter is connected to a primary side of a transformer, a secondary side of the transformer is connected to a power output terminal adapted to connect to the AC mains through two switches.

38. The UPS as claimed in claim 17, wherein the output terminal of the full-bridge inverter is connected to a primary side of a transformer, a secondary side of the transformer is connected to a power output terminal adapted to connect to the AC mains through two switches.

39. The UPS as claimed in claim 18, wherein the output terminal of the full-bridge inverter is connected to a primary side of a transformer, a secondary side of the transformer is connected to a power output terminal adapted to connect to the AC mains through two switches.

40. The UPS as claimed in claim 19, wherein the output terminal of the full-bridge inverter is connected to a primary side of a transformer, a secondary side of the transformer is connected to a power output terminal adapted to connect to the AC mains through two switches.

41. The UPS as claimed in claim 20, wherein the output terminal of the full-bridge inverter is connected to a primary side of a transformer, a secondary side of the transformer is connected to a power output terminal adapted to connect to the AC mains through two switches.

42. The UPS as claimed in claim 21, wherein the output terminal of the full-bridge inverter is connected to a primary side of a transformer, a secondary side of the transformer is connected to a power output terminal adapted to connect to the AC mains through two switches.

43. The UPS as claimed in claim 22, wherein the output terminal of the full-bridge inverter is connected to a primary side of a transformer, a secondary side of the transformer is connected to a power output terminal adapted to connect to the AC mains through two switches.

44. The UPS as claimed in claim 23, wherein the output terminal of the full-bridge inverter is connected to a primary side of a transformer, a secondary side of the transformer is connected to a power output terminal adapted to connect to the AC mains through two switches.

45. The UPS as claimed in claim 24, wherein the output terminal of the full-bridge inverter is connected to a primary side of a transformer, a secondary side of the transformer is connected to a power output terminal adapted to connect to the AC mains through two switches.

46. The UPS as claimed in claim 25, wherein the output terminal of the full-bridge inverter is connected to a primary side of a transformer, a secondary side of the transformer is connected to a power output terminal adapted to connect to the AC mains through two switches.

47. The UPS as claimed in claim 26, wherein the output terminal of the full-bridge inverter is connected to a primary side of a transformer, a secondary side of the transformer is connected to a power output terminal adapted to connect to the AC mains through two switches.

48. The UPS as claimed in claim 27, wherein the output terminal of the full-bridge inverter is connected to a primary side of a transformer, a secondary side of the transformer is connected to a power output terminal adapted to connect to the AC mains through two switches.

49. The UPS as claimed in claim 28, wherein the output terminal of the full-bridge inverter is connected to a primary side of a transformer, a secondary side of the transformer is connected to a power output terminal adapted to connect to the AC mains through two switches.
